(19) United States
(12) Patent Application Publication
(10) Pub. No.: US 2026/0281683 A1
(43) Pub. Date: Sep. 17, 2026

(54) MAINTAINING LOCATION CONTINUITY OF CALL HANDOVERS BETWEEN WI-FI AND CELLULAR NETWORKS

(71) Applicant: DISH Wireless L.L.C., Englewood, CO (US)

(72) Inventors: Raghavendhra Rao, Littleton, CO (US); Mehdi Alasti, Herndon, VA (US)

(21) Appl. No.: 19/081,494

(22) Filed: Mar. 17, 2025

(51) Int. Cl. H04W 4/90; H04W 4/029

(52) U.S. Cl. CPC H04W 4/90; H04W 4/029

(57) ABSTRACT

Systems and methods for maintaining location continuity for emergency call (or other non-emergency calls that utilize a location-based service) handovers between Wi-Fi and cellular network. A first location of a user device making an emergency call is determined using a cellular network location determination mechanism. The emergency call and the first location are forwarded to emergency services. While the emergency call is being managed between the user device and the emergency services via the cellular network, the emergency call is switched from the cellular network to Wi-Fi or vice versa during the ongoing emergency call. In response to switch, a second location of the user device is determined using a Wi-Fi location determination mechanism. An enhanced location of the user device is then selected and forwarded to the emergency services based on the first location and the second location.

### BACKGROUND

Mobile phones are being used more and more by more and more people. As the use of mobile phones has increased, so too has the need to make 911 calls from mobile phones. The speed at which emergency services can respond to a 911 call often relies on accurately identifying the caller's location. Unfortunately, identifying the caller's location can be difficult when the caller is moving around. Such movement can result in the caller moving from a place having cellular network coverage to a place lacking cellular network coverage (e.g., inside a large building or in an underground transportation tunnel). This type of movement can result in the call being dropped or switched from one access network to another. But some access networks may not be able to provide accurate or consistent location information. It is with respect to these and other considerations that the embodiments described herein have been made.

### BRIEF SUMMARY

Embodiments described herein provide location continuity and voice call continuity for emergency calls (or other non-emergency calls using location-based services) when the calls are switched (or a handover is performed) between access networks. Unfortunately, access networks may not be aware of such a switched emergency call. Moreover, Wi-Fi provides stand-alone location methods for emergency calls, which are typically not as accurate as location systems when an emergency call is connected to a cellular network (with no Wi-Fi). As a result, ongoing emergency calls that are switched between access networks can result in a discontinuity or inaccurate location information. Employing embodiments described herein can reduce or remove such discontinuities, which provides location continuity and voice call continuity for emergency calls when switched between access networks.

For example, if an emergency call is initiated using a cellular network (or the emergency call is originated on the cellular network) and is later switched to using Wi-Fi (or vice versa) for the same ongoing emergency call, then a first location of the user device when using a cellular network and a second location of the user device using a Wi-Fi may be utilized to determine an enhanced location for the user device. This enhanced location may be identified or selected from the first location and the second location based on an emergency call history for the user device, accuracy of the first and second locations, staleness of the first and second locations etc. Similarly, if an emergency call is initiated using Access Traffic Steering, Switching, and Splitting (ATSSS), then the first location of the user device may be determined using cellular network location determination mechanisms and a second location of the user device may be determined using Wi-Fi location determination mechanisms. The first and second locations can them be utilized to determine or select the current location for the user device.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for maintaining location continuity for emergency calls between Wi-Fi and a cellular network in accordance with embodiments described herein.

FIG. 2 is a context diagram of non-limiting embodiments of a system that provides location continuity for emergency calls switched between Wi-Fi and a cellular network in accordance with embodiments described herein.

FIG. 3 is a context diagram of non-limiting embodiments of another system that provides location continuity for emergency calls switch between Wi-Fi and a cellular network in accordance with embodiments described herein.

FIG. 4 is a context diagram of non-limiting embodiments of a system that provides location continuity for emergency calls employing Access Traffic Steering, Switching, and Splitting (ATSSS) between Wi-Fi and a cellular network in accordance with embodiments described herein.

FIG. 5 is a context diagram of non-limiting embodiments of another system that provides location continuity for emergency calls employing Access Traffic Steering, Switching, and Splitting (ATSSS) between Wi-Fi and a cellular network in accordance with embodiments described herein.

FIG. 6 illustrates a logical flow diagram showing one embodiment of a process for maintaining location continuity for emergency calls switched from a cellular network to Wi-Fi in accordance with embodiments described herein.

FIG. 7 illustrates a logical flow diagram showing one embodiment of a process for maintaining location continuity for emergency calls switched from Wi-Fi to a cellular network in accordance with embodiments described herein.

FIG. 8 illustrates a logical flow diagram showing one embodiment of a process for maintaining location continuity for emergency calls employing ATSSS between Wi-Fi and a cellular network in accordance with embodiments described herein.

FIG. 9 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

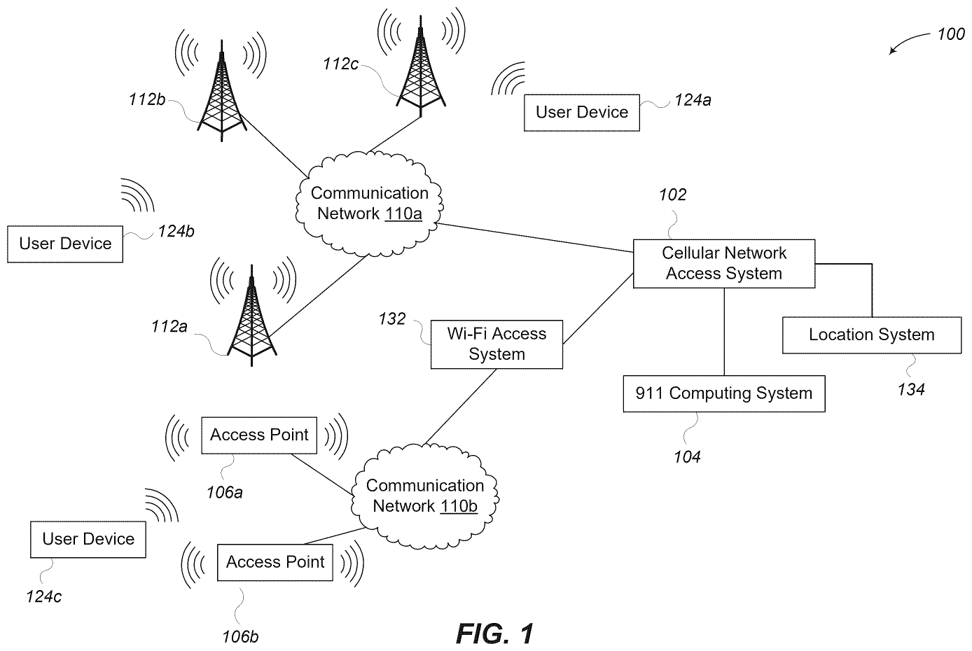

FIG. 1 illustrates a context diagram of an environment 100 for maintaining location continuity for emergency calls between Wi-Fi and a cellular network in accordance with embodiments described herein.

Environment 100 includes a plurality of cells 112a-112c, a plurality of user devices 124a-124c, a plurality of access points 106a-106c, a Wi-Fi access system 132, a cellular network access system 102, a location system 134, a 911 computing system 104, and communication networks 110a-110b.

The 911 computing system 104 is configured to support a 911 dispatcher in receiving emergency calls, supporting and handling emergency calls, and dispatching emergency services. In some embodiments, the 911 computing system 104 may be part of or referred to as a PSAP (Public Safety Answering Point). In various embodiments, the 911 computing system 104 is separate from the location system plane in the carrier network. Although FIG. 1 shows a single 911 computing system 104 (or PSAP), embodiments are not so limited. In some embodiments, environment 100 may include a plurality of 911 computing systems 104 (or PSAPs), where each separate 911 computing system 104 (or PSAP) is utilized by dispatchers to answer emergency calls and dispatch fire, police, and ambulances to an emergency in a specific geographical area or region. In some other embodiments, the 911 computing system 104 may be referred to or considered as a gateway of the carrier network, which computes the location of a user device making an emergency call. The 911 computing system 104, or gateway, can then connect to the external PSAP(s) that take the actual emergency call and talk with the caller.

The cells 112a-112c are cellular towers that together provide the hardware infrastructure of a cellular communications network, e.g., a 5G cellular communications network, which is also referred to as a cellular network. The cells 112a-112c may include or be in communication with base stations, radio backhaul equipment, antennas, or other devices, which are not illustrated for ease of discussion. In various embodiments, the cells 112a-112c may communicate with each other via communication network 110a. The cells 112a-112c may be individually or collectively referred to as cell 112 or cells 112. Communication network 110a includes one or more wired or wireless networks carry information between computing devices. In some embodiments, the cells 112a-112c and the communication network 110a, along with other networking components not illustrated, may collectively be referred to as a wireless network or a cellular network that supports embodiments described herein.

The access points 106a-106b are computing devices that provide wireless connections between user devices 124a-124c and other computing devices using Wi-Fi. Access points 106a-106b may include routers, switches, servers, and other devices that enable communications and network traffic to be transmitted to and from user devices 124a-124c via Wi-Fi. The access points 106a-106b may be individually or collectively referred to as access point 106 or access points 106. The access points 106a-106b may communicate via one or more communication networks 110b. Communication network 110b includes one or more wired or wireless networks carry information between computing devices. Communication network 110b may be part of or separate from communication network 110a. In some embodiments, the access points 106a-106b and communication network 110b, along with other networking components not illustrated, may collectively be referred to as a Wi-Fi or a non-cellular (or non-3GPP) access network that supports embodiments described herein.

The user devices 124a-124c are mobile computing devices that communicate with each other or with other computing devices via a wireless network (e.g., the cellular network supported by the cells 112a-112c or Wi-Fi by access points 106a-106b). User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can make emergency calls or non-emergency calls via a wireless or cellular network. The user devices 124a-124c may be individually or collectively referred to as user device 124 or user devices 124.

In various embodiments, the user devices 124a-124c are configured to initiate or make emergency calls to the 911 computing system 104. The emergency call may be a voice call, RTT (real-time text), or other type of emergency call. Briefly, a user device 124 initiates an emergency call via Wi-Fi when connected to an access point 106 or via the cellular network when connected to a cell 112 (or both via Access Traffic Steering, Switching, and Splitting (ATSSS)). Although embodiments are discussed in terms of emergency calls, embodiments are not so limited. Rather, embodiments described herein may also be used for other calls or applications where location-based services are utilized and connectivity may switch between a cellular network and a non-cellular network.

If the emergency call is made via Wi-Fi, then the call is transmitted and routed to Wi-Fi access system 132 via an access point 106 and communication network 110b. If the emergency call is made via the cellular network, then the call is transmitted and routed to cellular network access system 102 via a cell 112 and communication network 110a. In various embodiments, the Wi-Fi access system 132 and the cellular network access system 102 collectively be referred to as the call control plane. The Wi-Fi access system 132 is a server, computing device, cloud computing environment, or some other computing system configured to coordinate, facilitate, maintain, and manage emergency calls between the user devices 124a-124c and the 911 computing system 104 via Wi-Fi. In some embodiments, the Wi-Fi access system 132 provides an interface between the cellular network access system 102 and Wi-Fi so that the network core of the cellular network access system can provide additional communication functionality. The cellular network access system 102 is a server, computing device, cloud computing environment, or some other computing system configured to coordinate, facilitate, maintain, and manage the emergency call between user device 124a-124c and the 911 computing system 104 via a cellular network.

The location system 134 is a server, computing device, cloud computing environment, or some other computing system configured to receive an emergency call (e.g., 911 calls) or an indication of an emergency call being made from user devices 124, such as via Wi-Fi Access System 132 or cellular network access system 102. In some embodiments, the location system 134 initially receives the emergency call, but transfers or hands off the emergency call to the 911 computing system 104 back to the cellular network access system 102 (or the Wi-Fi Access System 132), such that the emergency-call-management system 102 is not an intermediary during the remainder of the emergency call. In other embodiments, the location system 134 operates as an intermediate for emergency calls between the user devices 124 and the 911 dispatcher and 911 computing system 104. In some embodiments, the location system 134 may be referred to or part of the location services plane.

In response to receiving a cellular network emergency call, the cellular network access system 102 obtains a location of the user device 124 by employing location system 134. The location system 134 employs one or more cellular network location determination mechanisms to obtain, determine, or select the location of the user device 124. The cellular network location determination mechanisms may include, but are not limited to, obtaining the location from the user device, employing a Location Management Function/Gateway Mobile Location Centre (LMF/GMLC) to obtain the location, etc. The location system 134 provides the location of the user device 124 back to the cellular network access system 102 so that the emergency call and location can be forwarded to the appropriate 911 dispatcher or PSAP (i.e., the appropriate 911 computing system 104).

In response to receiving a Wi-Fi emergency call, the Wi-Fi access system 132 provides the emergency call to the cellular network access system 102. In various embodiments, the Wi-Fi access system is an interface between the access points using Wi-Fi and the cellular network access system 102. The cellular network access system 102 can then obtain a location of the user device 124 by employing location system 134. But when Wi-Fi is being used, the location system 134 employs one or more Wi-Fi location determination mechanisms to obtain, determine, or select the location of the user device 124. The Wi-Fi location determination mechanisms may include, but are not limited to, obtaining the location from the user device, obtaining a physical address of the correspondingly connected access point, etc. The location system 134 provides the location of the user device 124 back to the cellular network access system 102 so that the emergency call and location can be forwarded to the appropriate 911 dispatcher or PSAP (i.e., the appropriate 911 computing system 104). In some other embodiments, the Wi-Fi access system 132 may communicate (not illustrated) with the location system 134 and the 911 computing system 104 without the cellular network access system 102.

The location system 134 is also configured to employ embodiments herein to maintain location continuity when emergency calls are handed over from Wi-Fi to a cellular network or from the cellular network to Wi-Fi. For example, a user device 124 may initiate an emergency call using Wi-Fi via the Wi-Fi access system 132. But during the call, management may be switched or handed-over to the cellular network via the cellular network access system 102, such as if the signal strength between the user device 124 and the access point 106 falls below a threshold value (e.g., if the user holding the user device walks away from a building containing the access point). As another example, a user device 124 may initiate the emergency call using the cellular network via the cellular network access system 102. But during the call, management may be switched to Wi-Fi via the Wi-Fi access system 132, such as if the signal strength between the user device 124 and a cell 112 falls below a threshold value (e.g., if the user holding the user device walks into a building). The location system 134 can then utilize the location history of the emergency call while connected via Wi-Fi and while connected via the cellular network to determine an enhanced location for the user device 124. In this way, location continuity can be maintained from before the switch to another network to after the switch to another network.

Table 1 shows example access network switching scenarios in which embodiments described herein may be employed when a user device is in a non-roaming or home routed-roaming scenario.

TABLE 1

| Initial Access | Switched Access | |
|---|---|---|
| Network | Network | Scenario |
| 3 GPP 5G | Wi-Fi (ePDG) | Non-roaming |
| 3 GPP 5G | Wi-Fi (N3IWF) | Non-roaming |
| 3 GPP 5G | Wi-Fi (ePDG) | Home routed-roaming |
| 3 GPP 5G | Wi-Fi (N3IWF) | Home routed-roaming |
| Wi-Fi (ePDG) | 3 GPP 5G | Non-roaming |
| Wi-Fi (N3IWF) | 3 GPP 5G | Non-roaming |
| Wi-Fi (ePDG) | 3 GPP 5G | Home routed-roaming |
| Wi-Fi (N3IWF) | 3 GPP 5G | Home routed-roaming |

Although the Wi-Fi access system 132, the cellular network access system 102, and the location system 134 are illustrated as separate computing systems, embodiments are not so limited. Rather, the functionality of the Wi-Fi access system 132, the cellular network access system 102, and the location system 134 may be performed by a single computing system or by a plurality of computing systems. Moreover, although embodiments described herein discuss the user device as initiating or making an emergency call to 911, embodiments are not so limited. Rather, embodiments described herein may be employed with other types of emergencies (e.g., a 112 call, or some other emergency number) or other non-emergency calls utilizing location-based services (e.g., law enforcement tracking, gaming applications, social media applications, etc.).

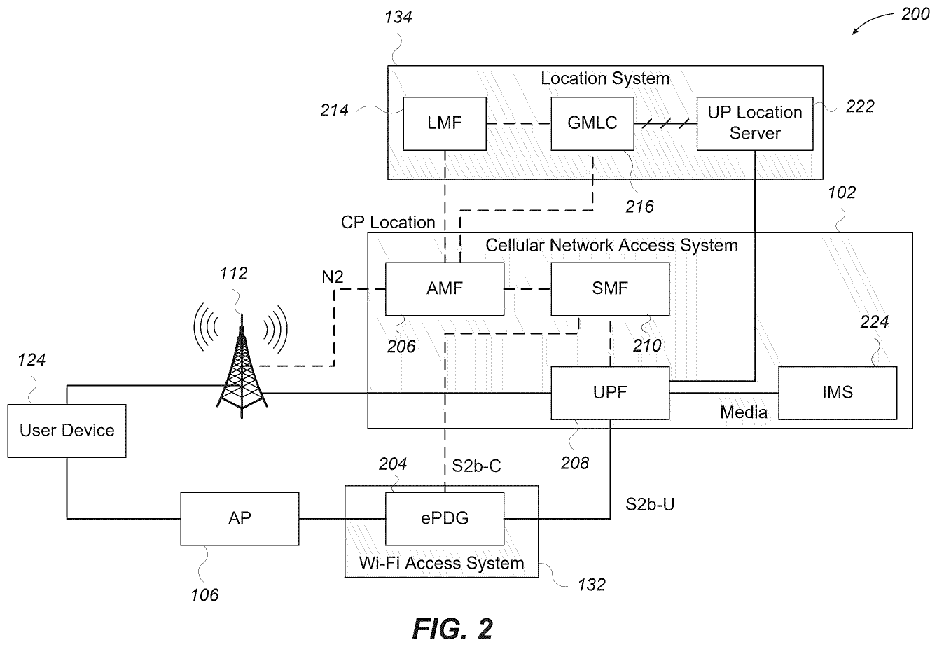

FIG. 2 is a context diagram of non-limiting embodiments of a system 200 that provides location continuity for emergency calls switched between Wi-Fi (using ePDG) and a cellular network in accordance with embodiments described herein.

System 200 includes a location system 134, a user device 124, a cell 112, an access point 106, a Wi-Fi access system 132, and a cellular network access system 102, similar to what is described in FIG. 1.

The cellular network access system 102 includes UPF (User Plane Function) 208, AMF (Access and Mobility Management Function) 206, SMF (Session Management Function) 210, and IMS (IP multimedia subsystem) 224. The UPF 208 may perform packet processing including routing and forwarding, quality of service (QoS) handling, and packet data unit (PDU) session management. The UPF may serve as an ingress and egress point for user plane traffic and provide anchored mobility support for user equipment. For example, the UPF 208 may control the or management of emergency calls (i.e., media) and user device location information between the user device 124 and emergency services (e.g., 911 computing system 104, not illustrated). The IMS 224 is a framework or network architecture that enables delivery of media associated with the emergency call between the cellular network and emergency services (e.g., 911 computing system 104 in FIG. 1), or between Wi-Fi and the emergency services. The AMF 206 may act as a single-entry point for a user device connection and perform mobility management, registration management, and connection management between a data network and user devices. In some embodiments, the AMF 206 provides the control plane location to the location system 124. The SMF 210 may perform session management, user plane selection, and IP address allocation.

The location system 134 includes LMF (location management function) 214, GMLC (gateway mobile location center) 216, and UP (User Plane) location server 222. LMF 214 receives measurement information from the cellular network and the user device 124 via the AMF 206 to compute the location or position of the user device 124. The GMLC 216 is the gateway to the PSAP and requests location information from the carrier network when a PSAP requests initial or updated location, such as when or during a 911 call. The GMLC 216 stores location information about a user device (i.e., subscriber) when that information is provided by the LMF 214 (via the AMF 206). The GMLC 216 enables accurate routing of emergency calls to the appropriate emergency dispatch center by providing location information needed for route determination. The UP location server 222 may store, maintain, or determine the location of the user device 124 to be accessed to obtain or determine user device location information or updated user device location for an emergency call. In some embodiments, the LMF 214 may also (alone or in combination with the UP location server 222) store, maintain, or determine the location of the user device 124 to be accessed to obtain or determine user device location information or updated user device location for an emergency call.

The Wi-Fi access system 132 includes an ePDG (Evolved Packet Data Gateway) 204. The ePDG 204 is an interface between a cellular network and Wi-Fi (or non-cellular or non-3GPP access networks). Thus, the ePDG 204 is utilized to access the cellular network access system 102 when the user device 124 makes an emergency call while connected to access point 106. In various embodiments, the ePDG 204 communicates control information to the SMF 210 using S2b-C communications and communicates user information to the UPF 208 using S2b-U communications.

The solid lines between the user device 124, the cell 112, the UPF 208, the UP location server 222, the IMS 224, the access point 106, and the ePDG 204 represent the routing of packets and information on the user plane. Although FIG. 2 shows a solid line between the user device 124 and both the cell 112 and the access point 106, the user device 124 would be connected to the cell 112 or the access point 106 but not both, at any given point in time during an emergency call. The dashed lines ( [symbol] ) between the cell 112, the AMF 206, the SMF 210, the UPF 208, the LMF 214, the GMLC 216, and the ePDG 204 represent the routing of packets and information on the control plane. The hashed lines ( [symbol] ) between the GMLC 216 and the UP location service 222 shows the connection between the GMLC 216 and the UP location service 222 in the location services plane.

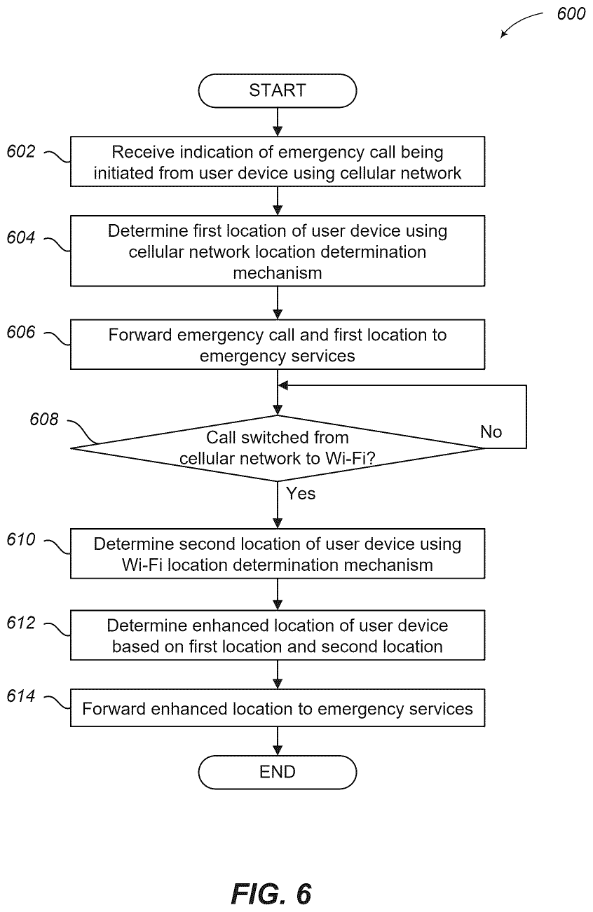

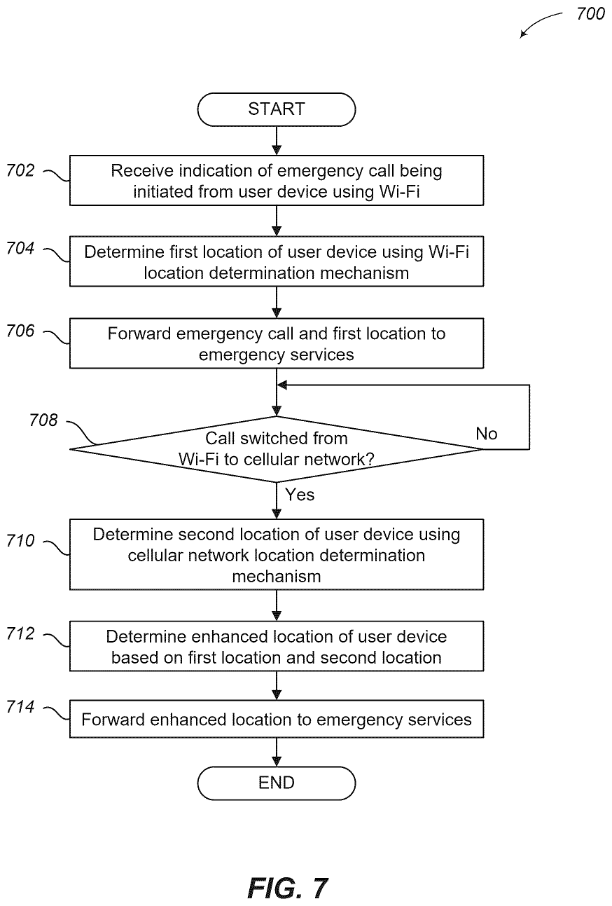

By employing embodiments described herein, the AMF 206 can provide a notification message to the location system 134 when an emergency call is switched between a cellular network via cell 112 and Wi-Fi via access point 106, or vice versa. As described herein, the location system 134 is employed to determine an enhanced location for the user device 124 after the switch based on location history information for emergency call, location accuracy information, location staleness information, or some combination thereof. In some embodiments, the location system 134 may employ one or more machine learning mechanisms to estimate the location of the user device after the emergency call is switched from one access network to another. The location system 134 may provide the enhanced location of the user device 124 to the UP location server 222 for storage and use in maintaining location continuity for the emergency call. In various embodiments, the location system 134 may perform processes 600 and 700 in FIGS. 6 and 7.

The cellular network access system 102 may include other core network functions that are not illustrated, which may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS).

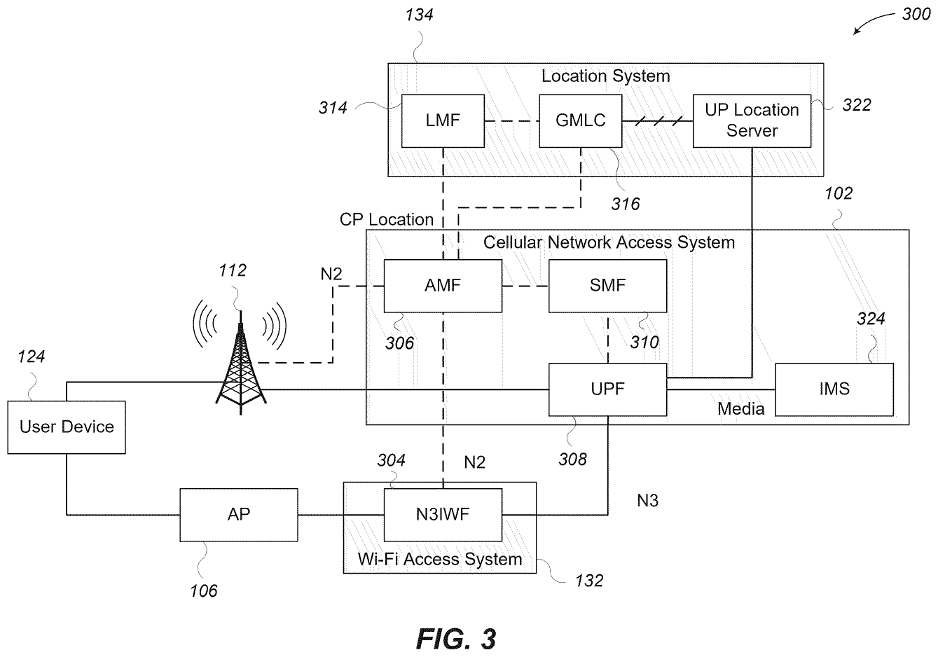

FIG. 3 is a context diagram of non-limiting embodiments of another system that provides location continuity for emergency calls switch between Wi-Fi (using N3IWF) and a cellular network in accordance with embodiments described herein.

System 300 includes a location system 134, a user device 124, a cell 112, an access point 106, a Wi-Fi access system 132, and a cellular network access system 102, similar to what is described in FIGS. 1 and 2. The location system 134 is configured to employing embodiments described herein (e.g., processes 600 and 700 in FIGS. 6 and 7) to determine an enhanced location for the user device 124 relative to an emergency call between switched form one access network to another.

The cellular network access system 102 includes UPF (User Plane Function) 308, AMF (Access and Mobility Management Function) 306, SMF (Session Management Function) 310, and IMS (IP multimedia subsystem) 324—which are similar to UPF 208, AMF 206, SMF 210, and IMS 224 shown in FIG. 2. The location system 134 includes LMF (location management function) 314, GMLC (gateway mobile location center) 316, and UP (User Plane) location server 322—which are similar to LMF 214, GMLC 216, and UP location server 222 shown in FIG. 2.

In this illustration, however, the Wi-Fi access system 102 includes N3IWF (non-3GPP interworking function) 304. The N3IWF 304 is a gateway between a cellular network and Wi-Fi (or non-cellular or non-3GPP access networks). Thus, the N3IWF 204 is utilized to access the cellular network access system 102 when the user device 124 makes an emergency call while connected to access point 106 using N2 and N3 interfaces. In various embodiments, the N3IWF 304 communicates control information to the AMF 306 using the N2 interface and communicates user information to the UPF 208 using the N3 interface.

The solid lines between the user device 124, the cell 112, the UPF 308, the UP location server 322, the IMS 324, the access point 106, and the N3IWF 304 represent the routing of packets and information on the user plane. Although FIG. 3 shows a solid line between the user device 124 and both the cell 112 and the access point 106, the user device 124 would be connected to the cell 112 or the access point 106, but not both, at any given point in time during an emergency call. The dashed lines ( [symbol] ) between cell 112, the AMF 306, the SMF 310, the UPF 308, the LMF 314, the GMLC 316, and the N3IWF 304 represent the routing of packets and information on the control plane. The hashed lines ( [symbol] ) between the GMLC 316 and the UP location service 322 shows the connection between the GMLC 316 and the UP location service 322 in the location services plane.

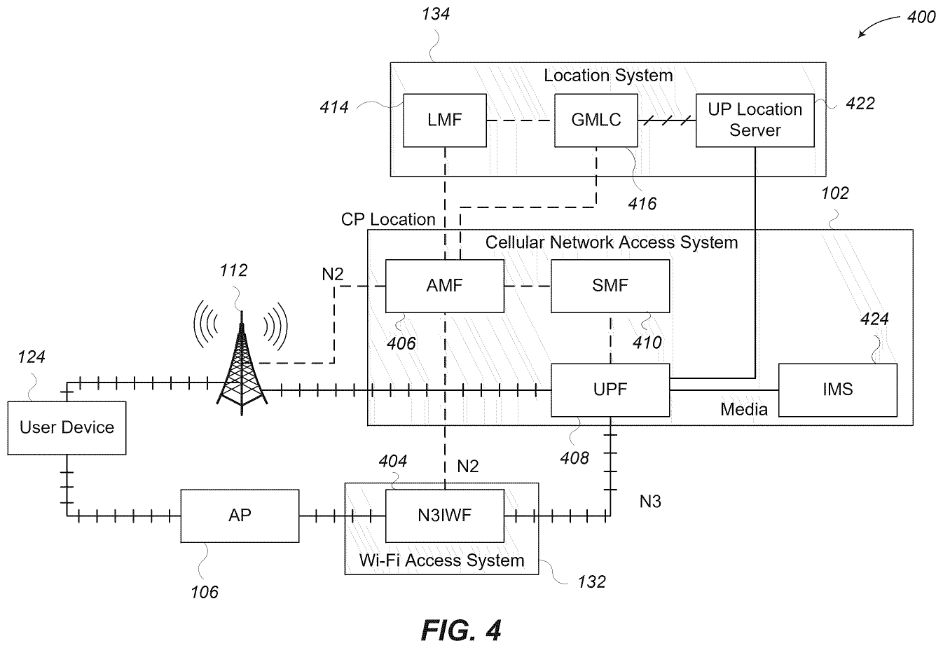

FIG. 4 is a context diagram of non-limiting embodiments of a system that provides location continuity for emergency calls employing Access Traffic Steering, Switching, and Splitting (ATSSS) between Wi-Fi and a cellular network in accordance with embodiments described herein.

System 400 includes a location system 134, a user device 124, a cell 112, an access point 106, a Wi-Fi access system 132, and a cellular network access system 102, similar to what is described in FIGS. 1-3.

The cellular network access system 102 includes UPF (User Plane Function) 408, AMF (Access and Mobility Management Function) 406, SMF (Session Management Function) 410, and IMS (IP multimedia subsystem) 424—which are similar to UPF 308, AMF 306, SMF 310, and IMS 324 shown in FIG. 3. The location system 134 includes LMF (location management function) 414, GMLC (gateway mobile location center) 416, and UP (User Plane) location server 422—which are similar to LMF 314, GMLC 316, and UP location server 322 shown in FIG. 3.

In this illustration, however, the user device is employing ATSSS to simultaneously connect to both the cellular network via cell 112 and Wi-Fi via access point 106. The Wi-Fi access system 102 includes N3IWF (non-3GPP interworking function) 404, which is similar to N3IWF 304 in FIG. 3.

The cross lines ( [symbol] ) between the user device 124, the cell 112, the UPF 408, the access point 106, and the N3IWF 404 represent simultaneously active connections for the routing of packets and information on the user plane. Accordingly, the cross lines between the user device 124 and both the cell 112 and the access point 106 indicate that the user device 124 could be connected to both the cell 112 and the access point 106 using ATSSS at any given point in time during an emergency call. The solid lines between the UP location server 422 and the IMS 424 represent additional connections for the routing of packets and information on the user plane. The dashed lines ( [symbol] ) between the cell 112, the AMF 406, the SMF 410, the UPF 408, the LMF 414, the GMLC 416, and the N3IWF 404 represent the routing of packets and information on the control plane. The hashed lines ( [symbol] ) between the GMLC 416 and the UP location service 422 shows the connection between the GMLC 416 and the UP location service 422 in the location services plane.

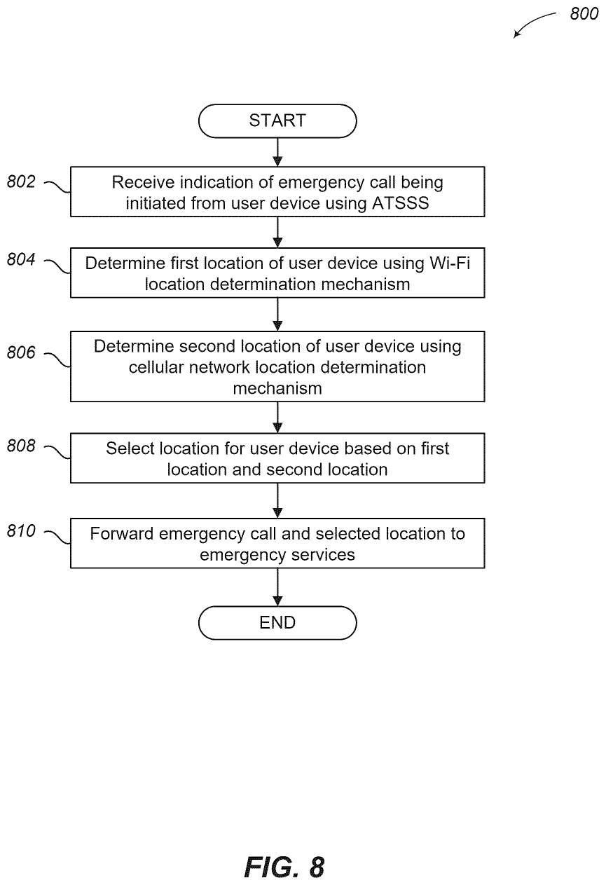

The location system 134 is configured to employing embodiments described herein (e.g., process 800 in FIG. 8) to determine a location of the user device 124 for an emergency call independent of the access network being communicated on between the user device 124 and emergency services. For example, if the user device is transmitting voice data via Wi-Fi, the location system 134 can utilize cellular network location determination mechanisms to select the location of the user device 124, which the UPF 408 can use and provide to the emergency services.

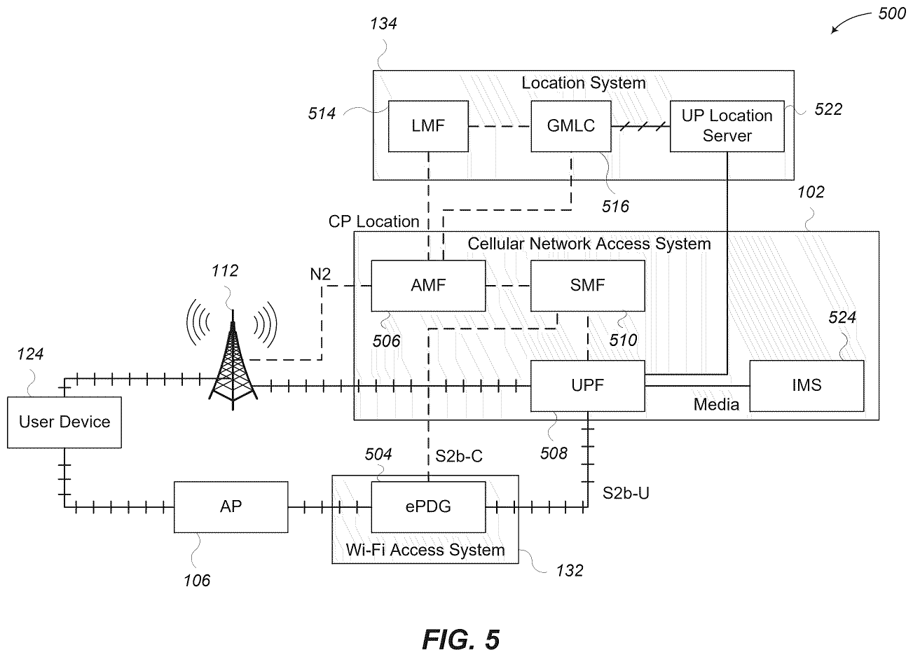

FIG. 5 is a context diagram of non-limiting embodiments of another system that provides location continuity for emergency calls employing Access Traffic Steering, Switching, and Splitting (ATSSS) between Wi-Fi and a cellular network in accordance with embodiments described herein.

The cellular network access system 102 includes UPF (User Plane Function) 508, AMF (Access and Mobility Management Function) 506, SMF (Session Management Function) 510, and IMS (IP multimedia subsystem) 524—which are similar to UPF 408, AMF 406, SMF 410, and IMS 424 shown in FIG. 4. The location system 134 includes LMF (location management function) 514, GMLC (gateway mobile location center) 516, and UP (User Plane) location server 522—which are similar to LMF 414, GMLC 416, and UP location server 422 shown in FIG. 4.

In this illustration, however, the Wi-Fi access system 102 includes ePDG 504, which is similar to ePDG 204 in FIG. 2.

The cross lines ( [symbol] ) between the user device 124, the cell 112, the UPF 508, the access point 106, and the ePDG 504 represent simultaneously active connections for the routing of packets and information on the user plane. Accordingly, the cross lines between the user device 124 and both the cell 112 and the access point 106 indicate that the user device 124 could be connected to both the cell 112 and the access point 106 using ATSSS at any given point in time during an emergency call. The solid lines between the UP location server 522 and the IMS 524 represent additional connections for the routing of packets and information on the user plane. The dashed lines ( [symbol] ) between the cell 112, the AMF 506, the SMF 510, the UPF 508, the LMF 514, the GMLC 516, and the ePDG 504 represent the routing of packets and information on the control plane. The hashed lines ( [symbol] ) between the GMLC 516 and the UP location service 522 shows the connection between the GMLC 516 and the UP location service 522 in the location services plane.

Similar to FIG. 4, the location system 134 is configured to employing embodiments described herein (e.g., process 800 in FIG. 8) to determine a location of the user device 124 for an emergency call independent of the access network being communicated on between the user device 124 and emergency services.

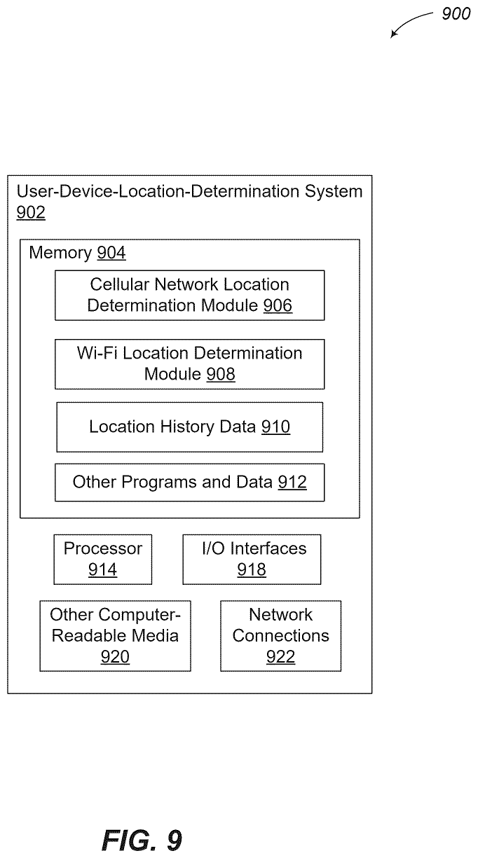

The operation of certain aspects will now be described with respect to FIGS. 6-8. Processes 600, 700, and 800 of FIGS. 6, 7, and 8, respectively, may be implemented by one or more processors or executed via circuitry on one or more computing devices, such as location system 134 in FIG. 1 or user-device-location-determination system 902 in FIG. 9.

FIG. 6 illustrates a logical flow diagram showing one embodiment of a process 600 for maintaining location continuity for emergency calls (or non-emergency calls utilizing a location-based service) switched from a cellular network to Wi-Fi in accordance with embodiments described herein.

Process 600 begins, after a start block, at block 602 where an emergency call or an indication of an emergency call being initiated from a user device using a cellular network is received. In some embodiments, a user of the device may activate, trigger, or initiate an emergency call via the user device, such as by dialing “911,” selecting or activating an “SOS” emergency action, etc. In other embodiments, an application or process on the user device may initiate the emergency call, such as an application that detects if the user is in a car accident and automatically calls 911. Emergency calls, also referred to as 911 calls or e911 calls, are phone calls or messages, or other emergency communications (e.g., voice calls, RTT, text messages, voice-over-Wi-Fi, etc.), made from a user device to a 911 dispatcher. Accordingly, the emergency call is received after it is initiated by the user device.

Moreover, the emergency call is initiated by the user device via a cellular network, either using a single access network or via ATSSS. For example, the user device is connected to or in communication via a cell tower of a cellular network. In this way, the cellular network receives the initiation of the emergency call, determines the appropriate emergency services (e.g., the PSAP associated with the location of the user device) for the emergency call, and coordinates the management of the emergency call between the user device and the emergency services via the cellular network.

Process 600 proceeds, after block 602, to block 604, where a first location of the user device is determined using a cellular network location determination mechanism. In some embodiments, the first location may be obtained using user plane location methods. For example, in various embodiments, the emergency call itself may include a location of the user device. In other embodiments, the user device may be queried for its location. In yet other embodiments, the first location may be obtained using control plane location methods (e.g., Location Management Function/Gateway Mobile Location Centre (LMF/GMLC)). In at least one embodiment, the location may be obtained from a Mobile Terminating Location Request (MT-LR). The location may include horizontal location data (x/y-axis) and vertical location data (z-axis) (e.g., a longitude, latitude, and elevation). In some embodiments, the location data may also include horizontal location uncertainty data and vertical location uncertainty data, along with the associated confidence.

Process 600 continues, after block 604, at block 606, where the emergency call and the first location are forwarded to emergency services or another computing system. In some embodiments, the system may select the appropriate 911 dispatcher or PSAP for the emergency call based on the first location of the user device. Once the 911 dispatcher or PSAP is selected, the system forwards or otherwise hands off the emergency call (along with the first location) to the 911 dispatcher or PSAP, while still being managed or maintained via the cellular network.

Process 600 proceeds, after block 606, to decision block 608, where a determination is made whether the call switched or was handed-over from the cellular network to Wi-Fi. In some embodiments, this determination is made in response to receiving a notification that management of the emergency call switched from the cellular network to Wi-Fi, such as from the AMF when the emergency call changes carriers using S2b-to-N3 switching techniques. In other embodiments, this determination may be made in response to a second emergency call being initiated from the same user device via Wi-Fi within a threshold time period (e.g., within 30 second) from the initial emergency call being dropped by the cellular network.

If the emergency call has switched from the cellular network to Wi-Fi, process 600 flows to block 610; otherwise, process 600 loops to decision block 608 to wait and determine if the emergency call is switched from the cellular network to Wi-Fi. If the emergency call ends and is not switched, then process 600 terminates (not illustrated).

At block 610, a second location of the user device is determined using a Wi-Fi location determination mechanism. In some embodiments, the second location may be obtained using user plane location methods. For example, in various embodiments, the emergency call itself may include a location of the user device. In other embodiments, the user device may be queried for its location. In other embodiments, a registered physical address of a Wi-Fi access point in which the user device is connected.

Process 600 proceeds, after block 610, to block 612, where an enhanced location of the user device is determined based on the first location and the second location. The enhanced location may be selected from the first location and the second location based on an accuracy of the locations, a timestamp or staleness of the locations, a call history of emergency calls from the user device, employment of one or more machine learning mechanisms, or some combination thereof. The enhanced location may also be referred to as a third location, a new location, a selected location, a system-determined current location, or other similar terms.

In some situations, the first location and the second location may not be within a threshold distance from one another, or the second location may not be within a select accuracy threshold. For example, assume the emergency call is being made within a large industrial complex that covers multiple acres. The first location may be an accurate GPS location of the user device, whereas the second location may be the physical address of an entry gate to the complex. In this scenario, the first location and the second location may be hundreds of meters apart. Thus, the first location may be more accurate than the second location. As another example, assume that the second location is the physical address of a coffee shop a kilometer away from the industrial complex. This difference may indicate that the user has move in the time from when the emergency call was initiated to when it switch to Wi-Fi. Thus, the second location may be more accurate than the first location.

In various embodiments, the location history of the emergency call may be used to select first location or the second location as the enhanced location. As noted above, switching of the emergency call from a cellular network to Wi-Fi may include dropping or disconnecting the emergency call via the cellular network and re-establishing a second emergency call via Wi-Fi, or it may include various network steering, switching, or splitting techniques. Accordingly, the location history or emergency call history may be defined as any information regarding the location or movement of a user device during one or more emergency calls that are deemed to be the “same” emergency call (e.g., multiple calls from the same user device within a threshold time period).

In some embodiments, the first location may be identified from the emergency call history for the user device, such as if the first location was determined for a previous emergency call via the cellular network that was dropped and reestablished via Wi-Fi. In this situation, the first location may be selected as the enhanced location of the user device.

In other embodiments, the system may determine whether the first location or the second location is a more accurate location, and then select the more accurate location as the enhanced location of the user device. For example, in some embodiments, the more accurate location may be the location with a more accurate uncertainty value associated with the location. In other embodiments, one or more machine learning mechanism may be employed to estimate a current location of the user device based on the location history. For example, the machine learning mechanisms may be trained using historical data associated with emergency calls, or with emergency calls that switched from a cellular network to Wi-Fi (or vice versa). In this way, such machine learning mechanisms are trained to compare the first location, the second location, and movement of the user device to determine an estimated location of the user device. In some embodiments, the more accurate location is the first location or the second location that is closer to the estimated location. In other embodiments, the estimated location itself may be selected as the enhanced location for the user device.

Process 600 continues, after block 612, at block 614, where the enhanced location of the user device is forwarded to the emergency services or other computing system. In some embodiments, the emergency call may have already been switched to Wi-Fi and forwarded or handed off to the emergency services. In this instance, only the enhanced location of the user device may be forwarded to the emergency services. In other embodiments, the switched emergency call may be a second emergency call via Wi-Fi, such that the system selects the same 911 dispatcher or PSAP for the switched emergency call. The system can forward or otherwise hand off the second or switched emergency call (along with the enhanced location) to the 911 dispatcher or PSAP, while still being managed or maintained via Wi-Fi.

After block 614, process 600 terminates or otherwise returns to a calling process to perform other actions. Although not illustrated, the emergency call may be managed or maintained via Wi-Fi until the call is ended, terminated, or switched back to a cellular network. In various embodiments, parts of process 600 may be performed multiple times throughout an emergency call so that the emergency services can receive updated location data throughout the emergency call. If the emergency call is switched back to a cellular network, then parts of process 700 in FIG. 7 may be employed to select a new or updated enhanced location for the user device.

FIG. 7 illustrates a logical flow diagram showing one embodiment of a process 700 for maintaining location continuity for emergency calls (or non-emergency calls utilizing a location-based service) switched from Wi-Fi to a cellular network in accordance with embodiments described herein.

Process 700 begins, after a start block, at block 702 where an emergency call or an indication of an emergency call being initiated from a user device using Wi-Fi is received. In some embodiments, the user device may initiate an emergency call similar to what is described in block 602 in FIG. 6, but such an emergency call is made through a connected Wi-Fi access point, either using a single access network or via ATSSS, rather than solely or primary through a cell tower of a cellular network.

Process 700 proceeds, after block 702, to block 704, where a first location of the user device is determined using a Wi-Fi location determination mechanism. In various embodiments, block 704 may employ embodiments of block 610 in FIG. 6 to determine the location of the user device using a Wi-Fi location determination mechanism.

Process 700 continues, after block 704, at block 706, where the emergency call and the first location are forwarded to emergency services or another computing system. In various embodiments, block 706 may employ embodiments of block 606 in FIG. 6 to forward the emergency call and location of the user device to the emergency services.

Process 700 proceeds, after block 706, to decision block 708, where a determination is made whether the call switched or was handed-over from Wi-Fi to a cellular network. In some embodiments, this determination is made in response to receiving a notification that management of the emergency call switched from Wi-Fi to a cellular network, such as from the AMF when the emergency call changes carriers using S2b-to-N3 switching techniques. In other embodiments, this determination may be made in response to a second emergency call being initiated from the same user device via a cellular network within a threshold time period (e.g., within 30 second) from the initial emergency call being dropped by via Wi-Fi.

If the emergency call has switched from Wi-Fi to a cellular network, process 700 flows to block 710; otherwise, process 700 loops to decision block 708 to wait and determine if the emergency call is switched from Wi-Fi to a cellular network. If the emergency call ends and is not switched, then process 700 terminates (not illustrated).

At block 710, a second location of the user device is determined using a cellular network location determination mechanism. In various embodiments, block 710 may employ embodiments of block 604 in FIG. 6 to determine the location of the user device using a cellular network location determination mechanism.

Process 700 proceeds, after block 710, to block 712, where an enhanced location of the user device is determined based on the first location and the second location. In various embodiments, block 712 may employ embodiments of block 612 in FIG. 6 to determine an enhanced location of the user device.

Process 700 continues, after block 712, at block 714, where the enhanced location of the user device is forwarded to the emergency services or other computing system. In various embodiments, block 714 may employ embodiments of block 614 in FIG. 6 to forward the enhanced location of the user device to the emergency services.

After block 714, process 700 terminates or otherwise returns to a calling process to perform other actions. Although not illustrated, the emergency call may be managed or maintained via the cellular network until the call is ended, terminated, or switched back to Wi-Fi. In various embodiments, parts of process 700 may be performed multiple times throughout an emergency call so that the emergency services can receive updated location data throughout the emergency call. If the emergency call is switched back to Wi-Fi, then parts of process 600 in FIG. 6 may be employed to select a new or updated enhanced location for the user device.

Although process 600 in FIG. 6 discusses an emergency call switching from a cellular network to Wi-Fi and process 700 in FIG. 7 discusses an emergency call switching from Wi-Fi to a cellular network, embodiments described herein may also be employed to determine or generate an enhanced location for a new, separate, or re-established emergency call made within a threshold amount of time from an initial emergency call—where the new, separate, or re-established emergency call is made from either the same access network or a separate access network or a different type of access network from which the initial emergency call is made.

For example, a first emergency call may be initiated from a user device using a first access network (i.e., Wi-Fi or a cellular network). A first location of the user device is determined for the first emergency call using a location determination mechanism of the first access network (e.g., by employing embodiments of block 604 in FIG. 6 if the first access network is a cellular network, or by employing embodiments of block 610 in FIG. 6 if the first access network is Wi-Fi). The first emergency call and the first location are then forwarded to emergency services or another computing system (e.g., by employing embodiments of block 606 in FIG. 6). If the first emergency call is dropped, terminated, or ended, but a second emergency call is initiated from the same user device using a second access network within a threshold time period (e.g., within 30 second from the first emergency call being dropped, terminated, or ended or from when the first emergency call was initiated), then the second emergency all may be considered to be part of or a continuation of the first emergency call. Again, the second access network may be the same access network as the first access network, or the second access network may be a separate access network from the first access network, or the second access network may be a different type of access network compared to first access network. A second location of the user device is determined for the second emergency call using a location determination mechanism of the second access network (e.g., by employing embodiments of block 604 in FIG. 6 if the first access network is a cellular network, or by employing embodiments of block 610 in FIG. 6 if the first access network is Wi-Fi). An enhanced location of the user device is then be determined based on the first location and the second location (e.g., by employing embodiments of block 612 in FIG. 6). The second emergency call and the enhanced location are then forwarded to emergency services or another computing system (e.g., by employing embodiments of block 614 in FIG. 6). In this way, the embodiments described herein to determine or generate an enhanced location can also be employed for new, separate, or re-established emergency calls using same, separate, or different access networks from the initial emergency call.

FIG. 8 illustrates a logical flow diagram showing one embodiment of a process 800 for maintaining location continuity for emergency calls (or non-emergency calls utilizing a location-based service) employing ATSSS between Wi-Fi and a cellular network in accordance with embodiments described herein.

Process 800 begins, after a start block, at block 702 where an emergency call or an indication of an emergency call being initiated from a user device using ATSSS (Access Traffic Steering, Switching, and Splitting) is received. In some embodiments, the user device may initiate an emergency call similar to what is described in block 602 in FIG. 6, but such an emergency call is made simultaneously through a cellular network and a connected Wi-Fi access point using the same user plane function through a multi-access protocol data unit. Managing the emergency call using ATSSS enables voice or text data for the emergency call to be transmitted using the cellular network or Wi-Fi. Likewise, location data for the user device can be obtained using a cellular network location determination mechanism or a Wi-Fi location determination mechanism, or both, independent of the actual access network being used to transmit voice or text data for the emergency call.

Process 800 proceeds, after block 802, to block 804, where a first location of the user device is determined using a Wi-Fi location determination mechanism. In various embodiments, block 704 may employ embodiments of block 610 in FIG. 6 to determine the location of the user device using a Wi-Fi location determination mechanism.

Process 800 continues, after block 804, at block 806, where a second location of the user device is determined using a cellular network location determination mechanism. In various embodiments, block 710 may employ embodiments of block 604 in FIG. 6 to determine the location of the user device using a cellular network location determination mechanism.

Process 800 proceeds, after block 806, to block 808, where a location for the user device is selected based on the first location and the second location. In various embodiments, block 808 may select the location for the user device similar to the selection of an enhanced location described in block 612 in FIG. 6. For example, location for the user device may be selected from the first location and the second location based on an accuracy of the locations, a timestamp or staleness of the locations, a call history of emergency calls from the user device, employment of one or more machine learning mechanisms, or some combination thereof.

Process 800 continues, after block 808, at block 810, where the emergency call and the selected location are forwarded to emergency services or another computing system. In various embodiments, block 810 may employ embodiments of block 606 in FIG. 6 to forward the emergency call and selected location of the user device to the emergency services.

After block 810, process 800 terminates or otherwise returns to a calling process to perform other actions. Although not illustrated, the emergency call is managed or maintained via ATSSS until it is ended or terminated. In various embodiments, parts of process 800 may be performed multiple times throughout an emergency call so that the emergency services can receive updated location data throughout the emergency call.

Although processes 600, 700, and 800 in FIGS. 6-8 are described with respect to emergency calls, embodiments are not so limited. Rather, processes 600, 700, and 800 may be employed for non-emergency calls or other calls that utilize or relate to location-based services.

FIG. 9 shows a system diagram that describe various implementations of computing systems 900 for implementing embodiments described herein. Systems 900 include user-device-location-determination system 902. System 900 may also include other devices, systems, and networks, as illustrated in FIGS. 1-5, but those other devices, systems, and networks are not shown in this figure for ease of illustration.

The user-device-location-determination system 902 is a computing system or environment that, in some embodiments, maintains location continuity for emergency calls that a switched between cellular and non-cellular access networks, as described herein. For example, user-device-location-determination system 902 may be an embodiment of location system 134 or one or more devices, systems, or components of location system 134 (e.g., GMLC or UP Location server), as described herein. One or more special-purpose computing systems may be used to implement the user-device-location-determination system 902. Accordingly, various embodiments described herein may be implemented in software, hardware, firmware, or in some combination thereof. In some embodiments, the user-device-location-determination system 902 may be included within or is the location services 102 described herein. The user-device-location-determination system 902 includes memory 904, processor 914, I/O interfaces 918, other computer-readable media 920, and network connections 922.

Processor 914 includes one or more processors, one or more processing units, programmable logic, circuitry, or one or more other computing components that are configured to perform embodiments described herein or to execute computer instructions to perform embodiments described herein. In some embodiments, a processor system may include a single processor 914 that operates individually to perform actions. In other embodiments, a processor system may include a plurality of processors 914 that operate to collectively perform actions, such that one or more processors 914 may operate to perform some, but not all, of such actions. Reference herein to “a processor system” refers to one or more processors 914 that individually or collectively perform actions. And reference herein to “the processor system” refers to 1) a subset or all of the one or more processors 914 comprised by “a processor system” and 2) any combination of the one or more processors 914 comprised by “a processor system” and one or more other processors 914.

Memory 904 may include one or more various types of non-volatile and/or volatile storage technologies. Examples of memory 904 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 904 may be utilized to store information, including computer-readable instructions that are utilized by a processor system to perform actions, including embodiments described herein.

Memory 904 may have stored thereon cellular network location determination module 906, Wi-Fi location determination module 908, and location history data 910. The cellular network location determination module 906 is configured to perform one or more cellular network location determination mechanisms to determine the location of a user device for an emergency call being managed via a cellular network, as described herein. The Wi-Fi location determination module 909 is configured to perform one or more Wi-Fi location determination mechanisms to determine the location of a user device for an emergency call being managed via Wi-Fi, as described herein. And the location history data 910 may store history location information for emergency calls of user devices, which can be used to determine an enhanced location of a user device in response to an emergency call being switched between access networks, as described herein.

Although the cellular network location determination module 906 and the Wi-Fi location determination module 908 are illustrated as separate modules, embodiments are not so limited. Rather, the functionality of the cellular network location determination module 906 and the Wi-Fi location determination module 908 may be employed by a single module or component or a plurality of modules or components.

Memory 904 may also store other programs and data 912 (e.g., operating systems, user device data, etc.).

Network connections 922 are configured to communicate with other computing devices, such as cellular network access system 102 (or in some embodiments, Wi-Fi access system 132, 911 computing system 104, or user devices 124a-124c). In various embodiments, the network connections 922 include transmitters and receivers (not illustrated) to send and receive data as described herein. I/O interfaces 918 may include one or more data input or output interfaces, video or display interfaces, or other input/output interfaces. Other computer-readable media 920 may include other types of stationary or removable computer-readable media, such as removable flash drives, external hard drives, or the like.

The following is a summarization of the original claims as filed.

A method may be summarized as comprising: receiving an indication of an emergency call being initiated by a user device using a cellular network; determining a first location of the user device using a cellular network location determination mechanism; and forwarding the emergency call and the first location to emergency services, wherein the emergency call is managed between the user device and the emergency services via the cellular network. During management of the emergency call via the cellular network, the method may include: determining that the emergency call switched from the cellular network to Wi-Fi; and in response to determining that the emergency call switched from the cellular network to Wi-Fi: determining a second location of the user device using a Wi-Fi location determination mechanism; determining an enhanced location of the user device based on the first location and the second location; and forwarding the enhanced location of the user device to the emergency services.

The method may determine that the emergency call switched from the cellular network to Wi-Fi including: receiving a notification that management of the emergency call switched from the cellular network to Wi-Fi.

The method may determine that the emergency call switched from the cellular network to Wi-Fi including: determining that a second emergency call was initiated from the user device via Wi-Fi within a threshold time period from the emergency call being dropped by the cellular network.

The method may determine the enhanced location of the user device including: identifying the first location from an emergency call history for the user device; and selecting the first location as the enhanced location of the user device.

The method may determine the enhanced location of the user device including: determining whether the first location or the second location is a more accurate location; and selecting the more accurate location as the enhanced location of the user device.

The method may determine the enhanced location of the user device including: determining whether the first location or the second location is a more recent location of the user device; and selecting the more recent location as the enhanced location of the user device.

The method may determine the enhanced location of the user device including: employing at least one machine learning mechanism to estimate a current location of the user device based on the first location, the second location, and movement of the user device; and selecting the estimated current location as the enhanced location of the user device.

The method may determine the second location of the user device using the Wi-Fi location determination mechanism including: receiving the second location from the user device as determined by the user device; or obtaining a registered address of a Wi-Fi access point in which the user device is connected.

The method may determine the first location of the user device using the cellular network location determination mechanism including: receiving the first location from the user device as determined by the user device; or employing control-plane location mechanism of the cellular network.

Another method may be summarized as comprising: receiving an indication of a call utilizing a location-based service being initiated by a user device using Wi-Fi; determining a first location of the user device using a Wi-Fi location determination mechanism; and forwarding the call and the first location to another computing system, wherein the call is managed between the user device and the other computing system via Wi-Fi. During management of the call via Wi-Fi, the method may include: determining that the call switched from Wi-Fi to a cellular network; and in response to determining that the call switched from Wi-Fi to the cellular network: determining a second location of the user device using a cellular network location determination mechanism; determining an enhanced location of the user device based on the first location and the second location; and forwarding the enhanced location of the user device to the other computing system.

The other method may determine that the call switched from Wi-Fi to the cellular network including: receiving a notification that management of the call switched from Wi-Fi to the cellular network.

The other method may determine that the call switched from Wi-Fi to the cellular network including: determining that a second call was initiated from the user device via the cellular network within a threshold time period from the emergency call being dropped by Wi-Fi.

The other method may determine the enhanced location of the user device including: identifying the first location from a call history for the user device; and selecting the first location as the enhanced location of the user device.

The other method may determine the enhanced location of the user device including: determining whether the first location or the second location is a more accurate location; and selecting the more accurate location as the enhanced location of the user device.

The other method may determine the enhanced location of the user device including: determining whether the first location or the second location is a more recent location of the user device; and selecting the more recent location as the enhanced location of the user device.

The other method may determine the enhanced location of the user device including: employing at least one machine learning mechanism to estimate a current location of the user device based on the first location, the second location, and movement of the user device; and selecting the estimated current location as the enhanced location of the user device.

The other method may determine the first location of the user device using the Wi-Fi location determination mechanism including: receiving the first location from the user device as determined by the user device; or obtaining a registered address of a Wi-Fi access point in which the user device is connected.

The other method may determine the second location of the user device using the cellular network location determination mechanism including: receiving the second location from the user device as determined by the user device; or employing control-plane location mechanism of the cellular network.

A system may be summarized as comprising: a memory configured to store first computer instructions; and a processor system configured to execute the first computer instructions to: receive an indication of an emergency call being initiated by a user device using Access Traffic Steering, Switching, and Splitting (ATSSS) between Wi-Fi and a cellular network; determine a first location of the user device using a Wi-Fi location determination mechanism; determine a second location of the user device using a cellular network location determination mechanism; select a current location of the user device based on the first location and the second location; and forward the emergency call and the selected current location to emergency services.

The processor system may select the current location of the user device by being configured to execute the first computer instructions to: determine whether the first location or the second location is a more accurate location; and select the more accurate location as the current location of the user device.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving an indication of an emergency call being initiated by a user device using a cellular network;
determining a first location of the user device using a cellular network location determination mechanism;
forwarding the emergency call and the first location to emergency services, wherein the emergency call is managed between the user device and the emergency services via the cellular network;
determining that the emergency call switched from the cellular network to Wi-Fi; and
in response to determining that the emergency call switched from the cellular network to Wi-Fi:
determining a second location of the user device using a Wi-Fi location determination mechanism;
determining an enhanced location of the user device based on the first location and the second location; and
forwarding the enhanced location of the user device to the emergency services.

2. The method of claim 1, wherein determining that the emergency call switched from the cellular network to Wi-Fi comprises:
receiving a notification that management of the emergency call switched from the cellular network to Wi-Fi.

3. The method of claim 1, wherein determining that the emergency call switched from the cellular network to Wi-Fi comprises:
determining that a second emergency call was initiated from the user device via Wi-Fi within a threshold time period from the emergency call being dropped by the cellular network.

4. The method of claim 1, wherein determining the enhanced location of the user device comprises:
identifying the first location from an emergency call history for the user device; and
selecting the first location as the enhanced location of the user device.

5. The method of claim 1, wherein determining the enhanced location of the user device comprises:
determining whether the first location or the second location is a more accurate location; and
selecting the more accurate location as the enhanced location of the user device.

6. The method of claim 1, wherein determining the enhanced location of the user device comprises:
determining whether the first location or the second location is a more recent location of the user device; and
selecting the more recent location as the enhanced location of the user device.

7. The method of claim 1, wherein determining the enhanced location of the user device comprises:
employing at least one machine learning mechanism to estimate a current location of the user device based on the first location, the second location, and movement of the user device; and
selecting the estimated current location as the enhanced location of the user device.

8. The method of claim 1, wherein determining the second location of the user device using the Wi-Fi location determination mechanism comprises:
receiving the second location from the user device as determined by the user device; or
obtaining a registered address of a Wi-Fi access point in which the user device is connected.

9. The method of claim 1, wherein determining the first location of the user device using the cellular network location determination mechanism comprises:
receiving the first location from the user device as determined by the user device; or
employing control-plane location mechanism of the cellular network.

10. A method, comprising:
receiving an indication of a call utilizing a location-based service being initiated by a user device using Wi-Fi;
determining a first location of the user device using a Wi-Fi location determination mechanism;
forwarding the call and the first location to another computing system, wherein the call is managed between the user device and the other computing system via Wi-Fi;
determining that the call switched from Wi-Fi to a cellular network; and
in response to determining that the call switched from Wi-Fi to the cellular network:
determining a second location of the user device using a cellular network location determination mechanism;
determining an enhanced location of the user device based on the first location and the second location; and
forwarding the enhanced location of the user device to the other computing system.

11. The method of claim 10, wherein determining that the call switched from Wi-Fi to the cellular network comprises:
receiving a notification that management of the call switched from Wi-Fi to the cellular network.

12. The method of claim 10, wherein determining that the call switched from Wi-Fi to the cellular network comprises:
determining that a second call was initiated from the user device via the cellular network within a threshold time period from the call being dropped by Wi-Fi.

13. The method of claim 10, wherein determining the enhanced location of the user device comprises:
identifying the first location from a call history for the user device; and
selecting the first location as the enhanced location of the user device.

14. The method of claim 10, wherein determining the enhanced location of the user device comprises:
determining whether the first location or the second location is a more accurate location; and
selecting the more accurate location as the enhanced location of the user device.

15. The method of claim 10, wherein determining the enhanced location of the user device comprises:
determining whether the first location or the second location is a more recent location of the user device; and
selecting the more recent location as the enhanced location of the user device.

16. The method of claim 10, wherein determining the enhanced location of the user device comprises:
employing at least one machine learning mechanism to estimate a current location of the user device based on the first location, the second location, and movement of the user device; and
selecting the estimated current location as the enhanced location of the user device.

17. The method of claim 10, wherein determining the first location of the user device using the Wi-Fi location determination mechanism comprises:
receiving the first location from the user device as determined by the user device; or
obtaining a registered address of a Wi-Fi access point in which the user device is connected.

18. The method of claim 10, wherein determining the second location of the user device using the cellular network location determination mechanism comprises:
receiving the second location from the user device as determined by the user device; or
employing control-plane location mechanism of the cellular network.

19. A system, comprising:
a memory configured to store first computer instructions; and
a processor system configured to execute the first computer instructions to:
receive an indication of a call being initiated by a user device using Access Traffic Steering, Switching, and Splitting (ATSSS) between Wi-Fi and a cellular network, wherein the call relates to a location of the user device;
determine a first location of the user device using a Wi-Fi location determination mechanism;
determine a second location of the user device using a cellular network location determination mechanism;
select a current location of the user device based on the first location and the second location; and
forward the call and the selected current location to another computing system.

20. The system of claim 19, wherein the processor system selects the current location of the user device by being configured to execute the first computer instructions to:
determine whether the first location or the second location is a more accurate location; and
select the more accurate location as the current location of the user device.
